(19) United States
(12) Patent Application Publication
(10) Pub. No.: US 2011/0025042 A1
(43) Pub. Date: Feb. 3, 2011

(54) Removal Tool

(76) Inventor: Alexander McKechran Hardie McNeil, New South Wales (AU)

Correspondence Address: WELLS ST. JOHN P.S., 601 W. FIRST AVENUE, SUITE 1300, SPOKANE, WA, 99201, US

(21) Appl. No.: 12/937,152

(22) PCT Filed: Apr. 17, 2009
(86) PCT No.: PCT/GB2009/000998

§ 371 Date: Oct. 8, 2010

(30) Foreign Application Priority Data
Apr. 18, 2008 (GB) 0807143.3

(51) Int. Cl. F16L 25/00

(52) U.S. Cl. 285/39

(57) ABSTRACT

The invention relates to a removal tool (10) for a pipe connection device (12). The removal tool (10) is selectively coupleable to a discrete connection device (12) which is configured for fitting to a member having an external groove in an outer surface of part thereof. The removal tool (10) is configured such that in a first position the removal tool (10) permits normal operation of the connection device (12) and in a second position the removal tool (10) facilitates release of the connection device (12) from the member.

### FIELD OF THE INVENTION

This invention relates to a removal tool. Particularly, but not exclusively, the invention relates to a removal tool for a connection device.

### BACKGROUND TO THE INVENTION

A variety of connection devices are available for use with piping or conduit and a particular use is for corrugated flexible pipes of the types commonly used to protect electrical cables and in other similar applications. However connection devices can also be used with members other than piping or conduit, for example to retain together respective elements of a plug and socket assembly.

Typical connection devices for use with corrugated flexible pipes include a tubular component arranged to receive an end portion of the pipe, the component having a plurality of spring fingers, each with a projection arranged to engage behind a ridge on the inserted corrugated pipe to retain it in the component.

Release of the pipe is, in some instances; possible by manipulation of the fingers by a suitable tool such as a screwdriver. Alternatively, the tool might take the form of a wrap configured to envelope a portion of the retained pipe and then be inserted into the end of the tubular component (the same end into which the pipe was inserted) to drive the fingers out of engagement with the pipe corrugation upon axial movement of the tool. A disadvantage associated with these types of tools is that they are often awkward to use, as they require simultaneous manipulation and movement of the tool with respect to the connection device. In addition, while it is possible to manipulate one tool such as a screwdriver to release one spring finger, it is extremely difficult to manipulate two or more tools, at substantially the same time, as may be required for connection devices having a plurality of fingers.

In other instances the connection device includes an integral release member, which is movable to release the fingers, thereby allowing removal of the pipe from the tubular component. The present Applicant has devised a connection device of this type, which is described in detail in GB2382633 and related applications. While such connection devices are often easier to operate when compared to the external tools described above, they have the disadvantage that the release member forms an integral part of the device, since this means that an unauthorised person can easily release the connection. This is especially undesirable in applications where the connection device is used in remote locations or areas where it may be prone to vandalism. In addition, it is possible that even without human intervention, the position of the release member may creep such that, over time, the connection is inadvertently released.

It is therefore an aim of the present invention to provide an improved removal tool.

### SUMMARY OF THE INVENTION

According to a first aspect of the present invention there is provided a removal tool selectively coupleable to a discrete connection device, said connection device being configured for fitting to a member having an external groove in an outer surface of part thereof; said removal tool being configured such that in a first position the removal tool permits normal operation of the connection device and in a second position the removal tool facilitates release of the connection device from the member.

It will be understood that the fitting of the connection device to the member and subsequent engagement thereof constitutes ‘normal’ operation of the connection device. In other words, in its first position the removal tool will either be completely passive to the operation of the connection device (i.e. have no influence on the functioning of the connection device) or have no significant influence such that the connection device is not prohibited from performing its purpose by the presence of the removal tool. The purpose of the removal tool is to help with the selective release of the member from the connection device when intentionally moved to its second position.

Thus, the present invention provides for a removal tool that can be selectively fitted to a connection device and may be retained on the connection device. However, it does not form an integral part of the connection device and does not prevent the normal operation of the connection device (i.e. it does not prohibit the locking, sealing or clamping mechanism of the connection device in its first, neutral or rest, position). As such, there is less risk of the connection device being released unintentionally, as can be the case for existing devices employed in dynamic applications.

Furthermore, the removal tool allows for easy and quick release of the connection device from the member without the need for manipulation of a further (unattached) tool or the specific manipulation of an integral part of the connection device itself. Consequently, it is believed that use of the present removal tool is more intuitive for an end user. Also, embodiments of the present invention can require less force to release the connection device from the member than in the prior art, yet again making use of the removal tool easier for an end user.

In addition, the removal tool of the present invention can be retrofitted to existing connection devices and can be left attached to the connection device for later use, if desirable.

A corrugated pipe may constitute the member.

The connection device may be self-locking (e.g. able to retain the member without requiring the application of an external force). The connection device may comprise a tubular component having at least one spring forger with a projection arranged to engage in said groove of the member to retain the member in the tubular component.

The removal tool may be coupleable to the connection device either when said connection device is not in use or when said connection device is in use (i.e. when said connection device is engaged in, or locked onto, a member).

The removal tool may be configured to wrap around the member, when engaged in said connection device, to permit subsequent coupling of the removal tool to the connection device. The removal tool may comprise two hollow half-cylinders hinged together along two adjacent sides such that they can wrap around another substantially cylindrical object such as the member or connection device.

The removal tool may be configured to locate on the exterior of the connection device. In which case, the removal tool may be configured to lift the fingers from engagement in the member. Alternatively, the removal tool may be configured to locate on the interior of the connection device. In which case, the removal tool may be configured to drive the fingers from engagement in the member.

The removal tool may be releasably coupleable to (i.e. detachable or separable from) the connection device. Consequently, the removal tool can be removed from the connection device when not required in order to reduce the risk of unauthorised or unintentional release of the connection device.

The removal tool may be configured to be locked to the connection device when attached thereto, in order to prevent unauthorised or unintentional removal of the tool itself.

The removal tool may be configured to rotate relative to the connection device to thereby move from said first position to said second position. It will be understood that in moving between the first and second positions there will be a transitional phase whereby the removal tool will be engaged with the connection device but the connection device will still retain the member.

The removal tool may comprise at least one arm extending axially from a substantially cylindrical collar. The at least one arm may comprise lifting means configured to engage with a part of the connection device so as to release it from engagement in a member. The lifting means may comprise a first surface configured to co-operate with a second surface on the finger of a connection device so as to move said finger out of engagement with the member. The first surface may take the form of a ramp configured to progressively raise said finger. The second surface may be the edge of the finger or may be a projection provided on a surface of the finger. For example, the second surface may be constituted by a projection provided on said finger for removing the connection device from a core pin after it has been moulded.

The at least one arm may further comprise a socket into which at least a part of the finger may be received, once it has been raised to a sufficient position to release the member, so as to hold the finger clear of the member. The at least one arm may be configured so as to provide a positive indication to the user (e.g. by sight, sound or touch) when the finger is disengaged from the member.

The at least one arm may further comprise a protuberance configured to maintain the finger in a raised position to facilitate release of the member. The protuberance may be arranged to provide feedback to a user, for example by way of an audible click, to indicate when the finger is raised to a sufficient position to release the member.

The at least one arm may be substantially stirrup-shaped and configured such that in the first position the finger is located within the stirrup and is free to engage in a member but the stirrup acts to couple the removal device to the connection device. It will be understood that such a removal device is configured for a snap-fit attachment to the connection device (i.e. the at least one arm of the removal device is inserted into the connection device and locked onto the connection device when the bottom portion of the stirrup is snapped into position behind a spring finger). The bottom portion of the stirrup may also be configured to retain the removal tool on the connection device even when the finger is lifted clear of the member (e.g. by providing a ledge which always overlaps in an axial direction with the edge of the finger).

Alternatively, the at least one arm may be substantially L-shaped to allow for quicker and easier disengagement with a connection device. In this embodiment, rotation of the removal device in one direction will axially lock the removal device to the connection device and permit lifting of the finger while rotation of the removal device in the other direction will permit it to be disengaged from the connection device.

In one embodiment of the present invention, at least two arms are provided and are arranged to engage with and lift respective fingers at different angles of rotation of the removal device with respect to the connection device. This may be advantageous since it staggers the time when force has to be applied in order to lift each finger and so makes the rotation of the removal device easier for a user.

The at least one arm may further comprise a leaf spring to bias the removal tool to a pre-determined position with respect to a connection device. The pre-determined position may be the first position or the second position.

The collar may be ridged to increase grip and facilitate easier rotation of the removal tool. The collar may include markings to indicate the direction of rotation for release of the member from the connection device.

According to a second aspect of the present invention there is provided a connection device for fitting to a member having an external groove in an outer surface of part thereof; coupled to a discrete removal tool configured such that in a first position the removal tool permits normal operation of the connection device and in a second position the removal tool facilitates release of the connection device from the member.

The removal tool may include any feature or combination of features described above.

A corrugated pipe may constitute the member.

The connection device may comprise a tubular component having at least one spring finger with a projection arranged to engage in said groove of the member to retain the member in the tubular component.

In certain embodiments, a plurality of spring fingers may be provided, each having a projection arranged to engage in said groove of the member.

The connection device may include a sealing means towards the end of the tubular component, opposite to the end where the member is inserted; said sealing means being configured to abut an end portion of the member to form a seal between the member and the connection device. A connector may be provided towards the end of the tubular component, opposite to the end where the member is inserted, for fixing the connection device to a further member or other component.

### BRIEF DESCRIPTION OF THE DRAWINGS

Embodiments of the invention will now be described, by way of example, with reference to the accompanying drawings, in which:

FIG. 1 illustrates a perspective view of a removal tool according to a first embodiment of the present invention, aligned for insertion into a first connection device;

FIG. 2 illustrates a view similar to that of FIG. 1 but with the removal tool attached to the connection device and placed in a first, neutral, position;

FIG. 3 illustrates a sectional view of the assembly of FIG. 2, taken along lines AA and BB;

FIG. 4A illustrates a top plan view of the assembly of FIG. 2;

FIG. 4B illustrates a longitudinal cross-sectional view taken along lines CC of FIG. 4A;

FIG. 4C illustrates a transverse cross-sectional view taken along lines DD of FIG. 4A;

FIG. 5A illustrates a top plan view of the assembly of FIG. 2, when the removal tool has been rotated clockwise (as viewed in the direction of arrows FF) to place the removal tool in a second, release, position;

FIG. 5B illustrates a longitudinal cross-sectional view taken along lines EE of FIG. 5A;

FIG. 5C illustrates a transverse cross-sectional view taken along lines FF of FIG. 5A;

FIG. 6 illustrates a perspective view of a removal tool according to a second embodiment of the present invention, aligned for insertion into a second connection device;

FIG. 7 illustrates a view similar to that of FIG. 6 but with the removal tool attached to the connection device and placed in a first, neutral, position;

FIG. 8 illustrates a sectional view of the assembly of FIG. 7, taken along lines GG and HH;

FIG. 9A illustrates a top plan view of the assembly of FIG. 7;

FIG. 9B illustrates a transverse cross-sectional view taken along lines II of FIG. 9A;

FIG. 10A illustrates a top plan view of the assembly of FIG. 7, when the removal tool has been rotated clockwise (as viewed in the direction of arrows JJ) to place the removal tool in a second, release, position;

FIG. 10B illustrates a transverse cross-sectional view taken along lines JJ of FIG. 10A;

FIG. 11A illustrates a transverse cross-sectional view similar to that of FIGS. 4C and 9B, wherein the removal tool is placed in a first, neutral, position, but for a third embodiment of the present invention; and

FIG. 11B illustrates a transverse cross-sectional view similar to that of FIG. 11A but when the removal tool has been rotated to place the removal tool in a second, release, position.

### DETAILED DESCRIPTION OF CERTAIN EMBODIMENTS

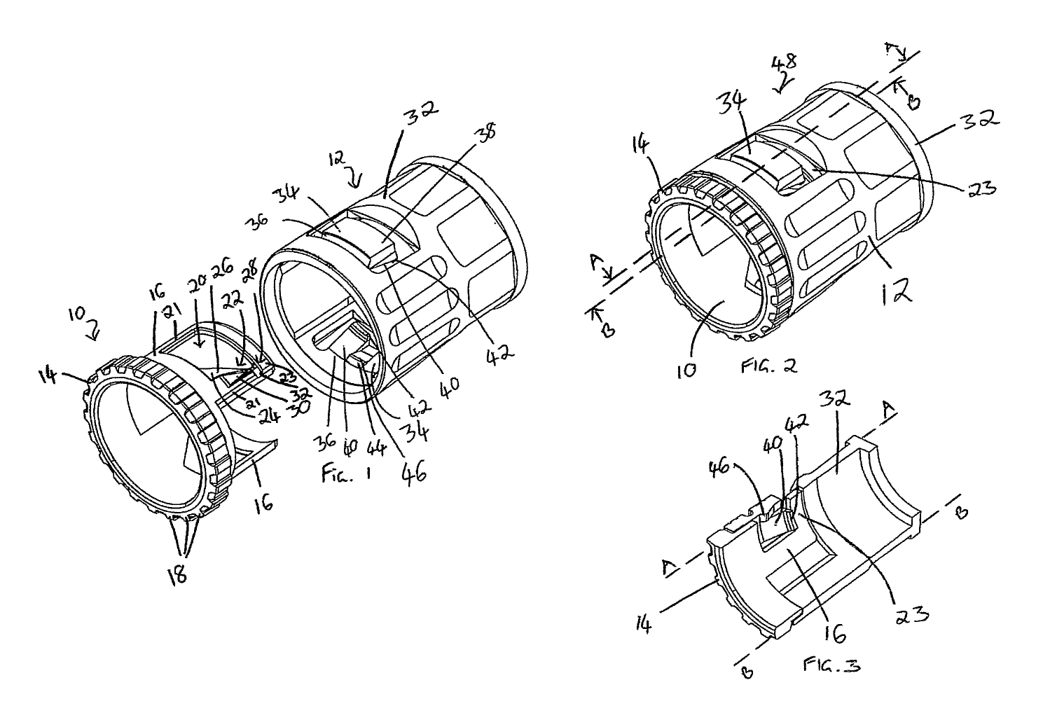

With reference to FIG. 1, there is illustrated a removal tool 10 according to a first embodiment of the present invention, aligned for axial insertion into a first connection device 12. The removal tool 10 comprises a cylindrical collar 14 with two radially opposite, identical arms 16 extending axially from the collar 14. The collar 14 comprises a plurality of ridges 18 around its circumference to aid with grip and facilitate rotation of the removal tool 10 when in use.

Each arm 16 is substantially stirrup-shaped and includes a window 20 bounded by two sides 21 and an interconnecting bottom strap 23. At a right-hand side 22 of each window 20 (when viewed externally from the collar 14) there is provided a lifting means 24 configured to engage with a part of the connection device 12, as will be described later. The lifting means 24 comprises a triangular ramp 26 increasing in depth towards the right-hand side 22. The triangular ramp 26 has its base parallel to the circumference of the collar 14, one side extending along the right-hand side 22 of the arm 16 and its tip in the far right-hand corner 28 of each arm 16.

A triangular protuberance 30 (i.e. bump) is also provided on the right-hand side 22 of each arm 16 to support the raised part of the connection device 12, as will be described later. A socket 32 in the form of a sunken channel is also provided at the far right-hand corner 28 of each arm 16 for location of the raised part.

The connection device 12 is configured for fitting to a member (not shown), such as a corrugated pipe, having an external groove in an outer surface of part thereof. The connection device 12 is constituted by a tubular component 32 having two radially opposite spring fingers 34. Each finger 34 is attached by a hinge 36 to the tubular component 32 such that the free end 38 of the spring finger 34 can move substantially radially into and out of the body of the tubular component 32. In addition, each finger 34 has an inclined internal surface 40 which increases in thickness away from the hinge 36. At the free end 38 of each finger 34 is a ledge 42 projecting radially into the tubular component 32. As can be seen from the lower finger 34 in FIG. 1, the internal central region 44 of each finger 34 is profiled to facilitate removal of the connection device 12 from a core pin during moulding. As such, the central region 44 includes a projection 46 close to the hinge 36 and at the fee end 38 the central region 44 is recessed when compared to the surrounding portions of the finger 34.

In use, the connection device 12 is configured such that upon insertion of a suitably sized member in the tubular component 32, the fingers 34 flex outwardly and spring back into the tubular component 32 so that the ledges 42 engage in an external groove of the member to retain the member in the connection device 12.

Although it may be possible to insert the end of a screwdriver under the fingers 34 (e.g. into the central recess) to lift the ledges 42 clear of the member and thereby allow the member to be removed from the connection device 12, this is awkward and time-consuming and so it is preferable to use the removal tool 10 according to the first embodiment of the present invention. In this particular embodiment, it is convenient to couple the removal tool 10 to the connection device 12 prior to the attachment of the member (as shown in FIG. 2). However, in some embodiments, for example, where the removal tool 10 is split in half longitudinally (not shown), it is possible to couple the removal tool 10 to the connection device 12 without first removing the member from the connection device 12.

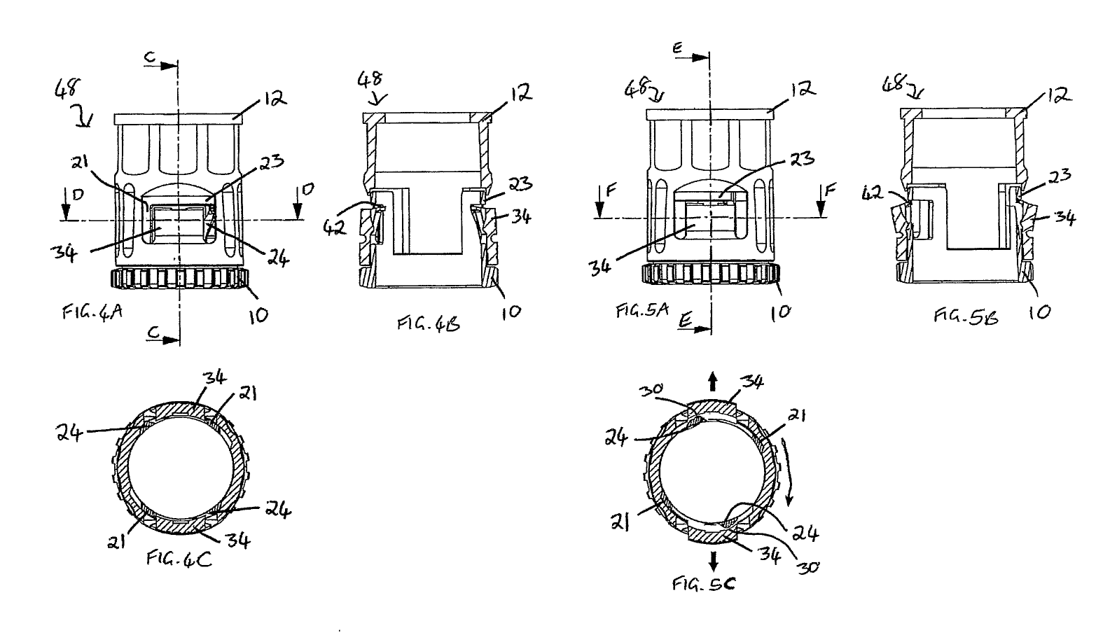

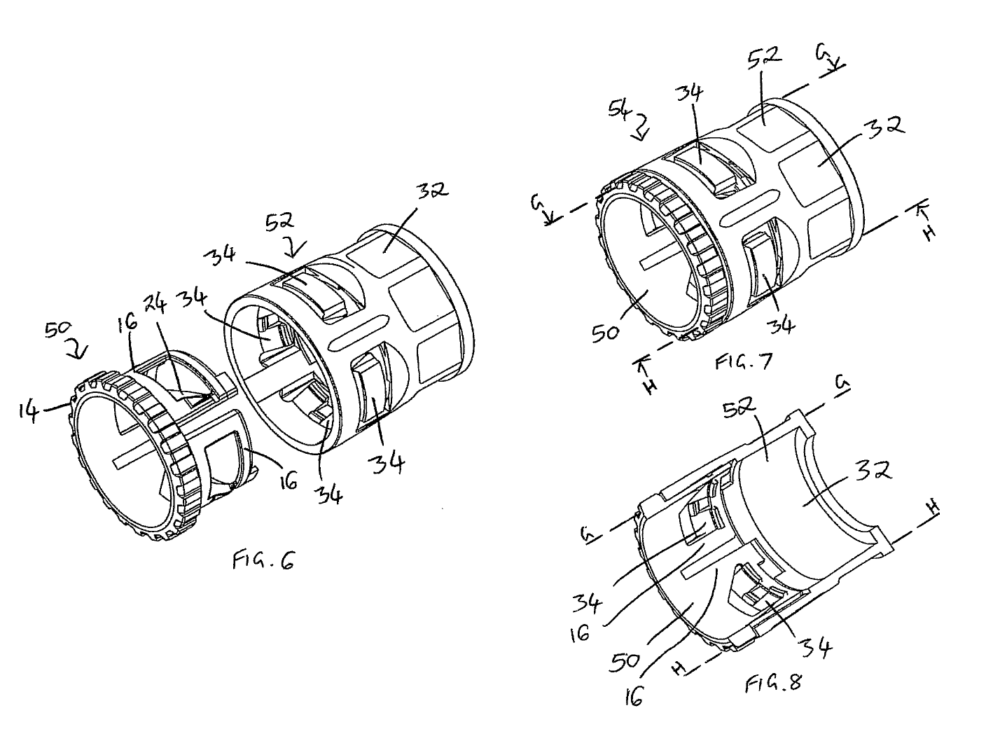

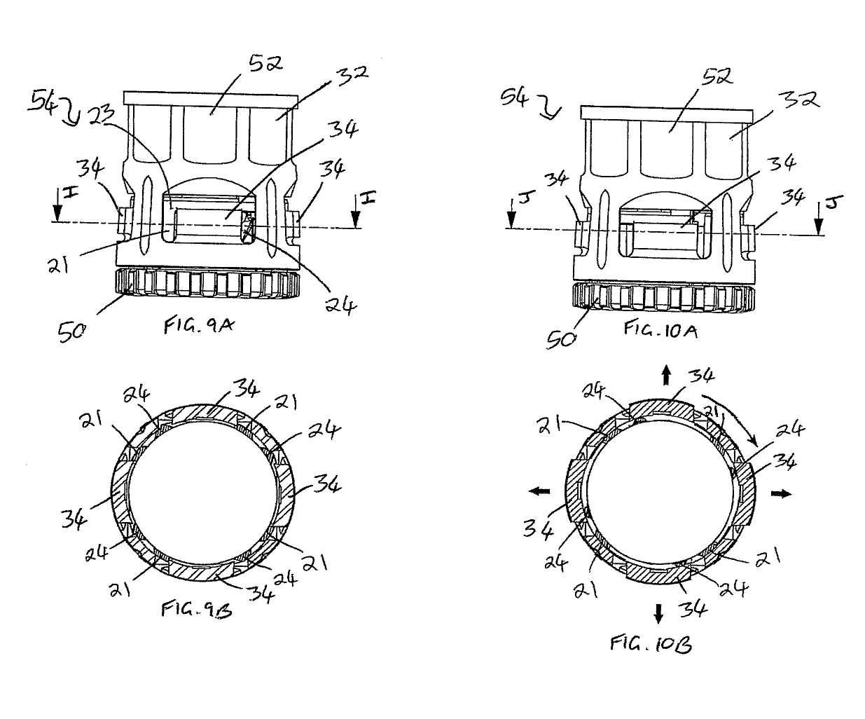

As shown in FIGS. 2 and 3, the removal tool 10 is inserted into the tubular component 32, from the same end in which the member would be inserted in use, to form an assembly 48. It will be understood that this particular removal device 10 is configured for a snap-fit attachment to the connection device 12. Thus, with the arms 16 of the removal device 10 aligned with the fingers 34 of the connection device 12, insertion of the removal device 10 into the connection device 12 causes the bottom straps 23 on each arm 16 to snap behind the ledges 42 of the fingers 34. The bottom straps 23 are conveniently arranged such that they are positioned axially behind the fingers 34 to thereby retain the removal tool 10 on the connection device 12. In this position, the collar 14 projects from the end of the connection device 12 so as to allow for rotation of the removal tool 10 with respect to the connection device 12. Each finger 34 is sized to fit comfortably within the windows 20 of the removal tool 10 so that, in this neutral position, the fingers 34 are permitted to flex under normal operation of the connection device 12 (i.e. for the capturing and retaining of a member therein). FIGS. 4A, 4B and 4C show alternative views of the assembly 48 illustrated in FIGS. 2 and 3, in this neutral position. Accordingly, it is shown that in this position the removal device 10, although coupled to the connection device 12, is passive to the functioning of the connection device 12 (e.g. the fingers 34 are free to flex to engage in the groove of an inserted member).

In order to engage the removal tool 10 and release the connection device 12 from an inserted member, the removal tool 10 should be rotated clockwise in this particular embodiment (as viewed in the direction of arrows FF in FIG. 5A) relative to the connection device 12. This rotation causes the lifting means 24 provided on each arm 16 of the removal tool to engage with each respective finger 34 to lift said finger 34 out of engagement with the member so as to place the removal tool 10 in its release position (see FIG. 5B). More specifically, the ramp 26 is brought into engagement with the inclined surface 40 of the finger 34 to progressively push the finger 34 outwardly. In other embodiments, the removal tool 10 may be configured to release the member from the connection device 12 by anti-clockwise rotation.

As illustrated in FIG. 5C the protuberance 30 is provided to hold the finger 34 in its raised position. In one embodiment, location of the finger 34 on the protuberance 30 causes an audible click to indicate to the user that the finger 34 is raised to a sufficient position to release the member. Alternatively, location of the ledge 42 in the socket 32 may provide an indication to the user that the member is now free to be disengaged from the connection device 12. That indication may be felt, seen or heard by the user. The fact that the ledge 42 is configured to locate in the socket 32 when the finger has been lifted to the desired degree means that the finger 34 still co-operates with the bottom strap 23 to retain the removal tool 10 on the connection device even when the connection device 12 is disengaged from the member.

If it is desirable for a particular application (i.e. in remote locations) to remove the removal tool 10 from the connection device 12 after use, this may be achieved by inserting screwdrivers under the fingers 34 to prise them clear of the removal tool 10. Other embodiments of the invention may be configured for easier release from the connection device 12, for example, by having an opening along side 21 of the removal tool 10, opposite to the lifting means 24.

FIGS. 6, 7 and 8 illustrate a removal tool 50, connection device 52 and assembly 54 (comprising the removal tool 50 coupled with the connection device 52) according to a second embodiment of the present invention. The removal tool 50 is similar to the removal tool 10 (of FIGS. 1 to 5C) and the connection device 52 is similar to the connection device 12 (of FIGS. 1 to 5C) and so like reference numerals will be used where appropriate. In fact, the only significant difference is that the removal tool 50 and connection device 52 have, respectively, four sets of arms 16 and four sets of fingers 34, as opposed to the two sets of arms 16 and fingers 34 in the first embodiment.

Operation of the assembly 54 is therefore similar to that of the assembly 48. Thus, as shown in FIGS. 9A and 9B, with the removal tool 50 in its neutral position, each of the four fingers 34 is free to move inwardly and outwardly of the tubular component 32 through respective windows 20 in each of the arms 16. Accordingly, normal operation of the connection device (e.g. for locking onto and retaining a member) is not obstructed.

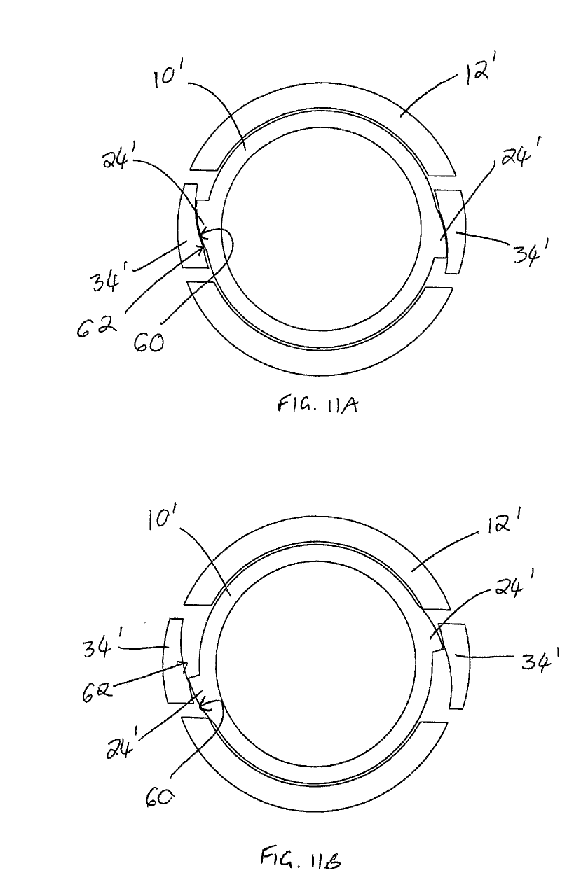

Furthermore, when the removal tool 50 is rotated clockwise (as viewed in the direction of arrows JJ in FIG. 10A) relative to the connection device 52, each of the lifting means 24 provided on each of the four arms 16 engage with the respective fingers 34 to lift said fingers 34 out of engagement with the member so as to place the removal tool 50 in its release position (see FIG. 10B). As described previously, this is achieved by the ramps 26 being brought into engagement with the inclined surfaces 40 of the fingers 34 to progressively push each of the four fingers 34 outwardly. The protuberance 30 then provides additional height to hold the fingers 34 clear of the member and the ledges 42 are permitted to locate in the sockets 32 to retain the fingers 34 in the release state whereby the member can be removed from the connection device 52.

FIGS. 11A and 11B show respectively, transverse cross-sectional views similar to that of FIGS. 4C and 5C but for a third embodiment of the present invention. As previously, like reference numerals will be employed for similar parts but with a′ indicating that the parts are not identical. Accordingly, in this embodiment, the removal tool 10′ includes two radially opposed lifting means 24′ configured to release two corresponding fingers 34′ provided on a connection device 12′. The lifting means 24′ has a curved outer surface 60 configured to engage with a complementary curved inner surface 62 on the fingers 34′. In a neutral position, as shown in FIG. 11A, the outer surface 60 and inner surface 62 lie adjacent one another and permit the ledge (not shown) depending from the finger 34′ to project into the connection device 12′ to engage with an inserted member. However, as shown in FIG. 11B, when the removal tool 10′ is rotated anti-clockwise (as viewed) the higher portion of the curved outer surface 60 slides into engagement with the higher portion of the curved inner surface 62 and this forces the fingers 34′ outwardly so that the ledge (not shown) is raised out of the groove of the member to thereby release it from the connection device 12′.

It will be understood that, in other embodiments, the outer surface 60 and inner surface 62 need not be curved and may be variously shaped in order to operate in a similar way to that described above. For example, the outer surface 60 and inner surface 62 may be oppositely inclined or stepped. Furthermore, in the neutral position (FIG. 11A), the outer surface 60 and inner surface 62 may be spaced further apart than shown in order to permit the finger 34′ to flex more easily to engage in an inserted member.

In alternative embodiments of the present invention (not shown), the lifting means 24 are arranged to engage with and lift the respective fingers 34 at different angles of rotation of the removal device 10 with respect to the connection device 12. This is particularly advantageous since it staggers the time when force has to be applied in order to lift each finger 34 and so makes the rotation of the removal device 10 easier for an end user.

It will be appreciated by persons skilled in the art that various modifications may be made to the above-described embodiments without departing from the scope of the present invention. For example, whilst the above discussion has been primarily concerned with connection devices configured for engagement in the groove of a corrugated pipe, the invention is equally applicable to other types of connection devices, such as those employed in plug and socket assemblies.

1-40. (canceled)

41. A removal tool selectively coupleable to a discrete connection device, said connection device being configured for fitting to a member having an external groove in an outer surface of part thereof; said removal tool being configured such that in a first position the removal tool permits normal operation of the connection device and in a second position the removal tool facilitates release of the connection device from the member.

42. A removal tool according to claim 41, configured to be releasably coupleable to the connection device.

43. A removal tool according to claim 41, configured to be retained on the connection device after being coupled thereto.

44. A removal tool according to claim 41, configured to be coupleable to the connection device when said connection device is in use.

45. A removal tool according to claim 41, configured to wrap around the member, when engaged in said connection device, to permit subsequent coupling of the removal tool to the connection device.

46. A removal tool according to claim 41, comprising two hollow half-cylinders hinged together along two adjacent sides such that they can wrap around another substantially cylindrical object.

47. A removal tool according to claim 41, wherein the connection device comprises a tubular component having at least one spring finger with a projection arranged to engage in said groove of the member to retain the member in the tubular component.

48. A removal tool according to claim 41, configured to rotate relative to the connection device to thereby move from said first position to said second position.

49. A removal tool according to claim 47, comprising at least one arm extending axially from a substantially cylindrical collar.

50. A removal tool according to claim 49, wherein the at least one arm comprises lifting means configured to engage with a part of the connection device so as to release it from engagement with the member.

51. A removal tool according to claim 50, wherein the lifting means comprises a first surface configured to co-operate with a second surface on the at least one spring finger of the connection device so as to move said at least one spring finger out of engagement with the member.

52. A removal tool according to claim 51, wherein the first surface is a ramp configured to progressively raise said at least one spring finger.

53. A removal tool according to claim 49, wherein the at least one arm may further comprise a socket into which at least a part of the at least one spring finger may be received, once it has been raised to a sufficient position to release the member, so as to hold the at least one spring finger clear of the member.

54. A removal tool according to claim 49, wherein the at least one arm is configured so as to provide a positive indication to the user when the at least one spring finger is disengaged from the member.

55. A removal tool according to claim 49, wherein the at least one arm is substantially stirrup-shaped and configured such that in the first position the at least one spring finger is located within the stirrup and is free to engage in a member and the stirrup acts to couple the removal device to the connection device.

56. A removal tool according to claim 55, wherein the at least one arm is configured such that insertion of the at least one arm into the connection device locks the removal tool onto the connection device when a bottom portion of the stirrup is snapped into position behind the at least one spring finger.

57. A removal tool according to claim 56, wherein the bottom portion of the stirrup is configured to retain the removal tool on the connection device even when the at least one spring finger is lifted clear of the member.

58. A removal tool according to claim 49, wherein the at least one arm is substantially L-shaped, such that rotation of the removal device in one direction axially locks the removal device to the connection device and permits lifting of the at least one spring finger while rotation of the removal device in the other direction permits it to be disengaged from the connection device.

59. A removal tool according to claim 49, wherein two or more arms are provided which are arranged to engage with and lift respective spring fingers at different angles of rotation of the removal device with respect to the connection device.

60. A connection device for fitting to a member having an external groove in an outer surface of part thereof; coupled to a discrete removal tool configured such that in a first position the removal tool permits normal operation of the connection device and in a second position the removal tool facilitates release of the connection device from the member.
